(19) United States
(12) Patent Application Publication
(10) Pub. No.: US 2008/0304392 A1
(43) Pub. Date: Dec. 11, 2008

(54) Hologram Storage System

(75) Inventor: Yuen-Lin Li, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Lite-On IT Corporation, Taipei City (TW)

(21) Appl. No.: 12/127,979

(22) Filed: May 28, 2008

(30) Foreign Application Priority Data
Jun. 7, 2007 (CN) 200710108434.3

(51) Int. Cl. G11B 7/00

(52) U.S. Cl. 369/103

(57) ABSTRACT

A hologram storage system having a plurality of data bits groups (each data bits group is related to each other, and all these data bits groups together constituted to a codeword) stored on different pages of a storage medium, so that the correcting ability of the ECC (error-correction coding) unit is enhanced.

### FIELD OF THE INVENTION

The present invention relates to a hologram storage system, and more particularly to a hologram storage system capable of storing a plurality of data bits groups (belong to a same codeword) to different pages of a storage medium.

### BACKGROUND OF THE INVENTION

FIG. 1 is a diagram showing a hologram storage system 100. The hologram storage system 100 comprises: a signal beam 12, a data plane 14, a reference beam 16, a storage medium 18, a data beam 20, and a detecting apparatus 22.

As depicted in FIG. 1, a light source (i.e., a laser light source) is split into two light beams by a beam splitter (not shown), wherein one of these two light beams is converted to the signal beam 12 after the light beam is emitted through the data plane 14, in another word, an image frame presented on the data plane 14 is also contained in the signal beam 12; and another light beam is the reference beam 16. When the signal beam 12 and the reference beam 16 are simultaneously focused on the storage medium 18, the image frame contained in the signal beam 12 is then stored in the storage medium 18. In another word, a focal point, generated by both the signal beam 12 and the reference beam 16 on the storage medium 18, serves as a page for storing a first image frame presented on the data plane 14. Accordingly, when a second image frame is present on the data plane 14, the second image frame can be stored at another focal point (page) through the signal beam 12 and the reference beam 16. When the hologram storage system 100 serves to read data, the reference beam 16 focuses on the page for generating a data beam 20. And, the detecting apparatus 22 is placed on the path of the data beam 20 for receiving the image frame originally present on the data plane 14.

When the hologram storage system 100 serves to store a codeword to the storage medium 18, the codeword is firstly divided to a plurality of data bits groups by an ECC (error-correction coding) unit. As depicted in FIG. 1, the codeword is divided to three data bits groups D1, D2, and D3. These three data bits groups D1, D2, and D3 are then sequentially presented on the data plane 14 as an image frame. When a light beam is emitted through the image frame, the light beam is converted to the signal beam 12 containing the image frame. When the signal beam 12 and the reference beam 16 are simultaneously focused on a page of the storage medium 18, the hologram storage system 100 completes storing the codeword to the page of the storage medium 18. When the hologram storage system 100 serves to read the data stored on the page of the storage medium 18, only the reference beam 16 is emitted to the page, and the data beam 20 containing the data bits groups D1, D2, and D3 is then generated and outputted from the extended direction of the signal beam 12. The detecting apparatus 22 then receives the data beam 20, and these three data bits groups D1, D2, and D3 are restored back to the codeword by the ECC unit.

Generally, the data plane 14 is a SLM (spatial light modulator), and the SLM can be a DMD (digital micro-mirror device) or a LCD (liquid crystal display). Both the DMD and the LCD are composed by a plurality of presenting units arranged as an array, and these presenting units with different intensities serve to present an image frame. In addition, the storage medium 18 is a Photopolymer. The detecting apparatus 20 can be a CCD (charge-coupled device) or a CMOS (complementary metal oxide semiconductor). Both the CCD and the CMOS are also composed by a plurality of sensing units arranged as an array, and these sensing units serve for receiving the image frame presented on the presenting units of the data plane 14.

The ability of the ECC unit to restore the data bits groups back to the codeword depends on the number of the error bits. In another word, the ECC unit may fail to restore the data bits groups back to the codeword if the number of the error bits in the data bits groups is higher than a specific number. Moreover, a related research disclosed that the error bits tend to occur at a same line, in another word, if these three data bits groups D1, D2, and D3 are sequentially presented on a same row/column of the data plane 14, a relatively high number of error bits may be resulted in, and the ECC unit may fail to restore the three data bits groups D1, D2, and D3 back to the codeword.

For fixing the problem, having a relatively high number of error bits resulted by a plurality of data bits groups sequentially presented on a same row/column of data plane, U.S. Pat. No. 5,812,288 discloses a new hologram storage system. The hologram storage system 300, depicted in FIG. 2, comprises: a signal beam 32, a data plane 34, a reference beam 36, a storage medium 38, a data beam 40, and a detecting apparatus 42.

When the hologram storage system 300 serves to store data, a codeword is firstly divided to a plurality of data bits groups by the ECC unit. As depicted in FIG. 2, the codeword is divided to three data bits groups D1, D2, and D3. These three data bits groups D1, D2, and D3 are then separately presented on different rows/or columns of the data plane 34 if the data plane 34 is regarded as a 2-dimension array. After the signal beam 32 and the reference beam 36 simultaneously focusing on a page of the storage medium 38, the hologram storage system 300 completes storing the codeword to the storage medium 38. When the hologram storage system 300 serves to read data, only the reference beam 36 is emitted to the page, and the data beam 40 containing the data bits groups D1, D2, D3 is then generated and outputted from the extended direction of the signal beam 32. The detecting apparatus 42 then receives the data beam 40, and these three data bits groups D1, D2, and D3 are restored back to the codeword by the ECC unit.

As depicted in FIG. 2, the data bits groups D1, D2, and D3 are presented at different rows/columns of the data plane 34. Therefore, only one data bits group among D1, D2, and D3 will be affected by the error bits if the error bits occur at a same row/column. Accordingly, the ECC unit still has the ability to restore these data bits groups back to the codeword. For example, if a page where the data bits groups D1, D2, D3 stored has a defect, and the defect results in a numbers of error bits at a same row/column where the data bits group D1 is stored, the ECC unit still has the ability to overcome the defect due to data bits groups D2 and D3 are stored at different rows/columns, so as the ECC unit still has the ability to restore the data bits groups D1, D2, and D3 back to a codeword.

The ECC unit can have higher ability to overcome a relatively small defect (i.e., a dust) if a plurality of data bits groups (belong to a same codeword) are separately stored at different rows/columns of the data plane. However, if the defect is relatively large (i.e., a fingerprint or a scratch), or a whole page is affected by a vibration, the ECC unit may still fail to restore the plurality of data bits groups to the codeword.

### SUMMARY OF THE INVENTION

Therefore, the present invention provides a hologram storage system to make the ECC unit has a higher ability to overcome a relatively large defect.

The present invention provides a hologram storage system, comprising: a codeword capable of being divided to a plurality of data bits groups by an error-correction coding unit; a data plane, for sequentially presenting a plurality of image frames, wherein each image frame contains a portion of the data bits groups; a storage medium, for storing the plurality of sequentially-presenting image frames; a signal beam containing the plurality of sequentially-presenting image frames; and, a reference beam together with the signal beam to form a focal point; wherein the focal point can be moved to a plurality of positions in the storage medium according to the plurality of sequentially-presenting image frames.

The present invention provides a hologram storage system, comprising: a codeword capable of being divided to a plurality of data bits groups by an error-correction coding unit; a data plane, for sequentially presenting a plurality of image frames, wherein each image frame contains a portion of data bits groups; a storage medium, for storing the plurality of sequentially-presenting image frames; a signal beam containing the plurality of sequentially-presenting image frames; and, a reference beam together with the signal beam to form a focal point; wherein the focal point can be moved to a plurality of depths of a position in the storage medium according to the plurality of sequentially-presenting image frames.

The present invention provides a hologram storing method, applied to a hologram storage system, comprising steps of: dividing a codeword, ready to be stored in the hologram storage system, to a plurality of data bits groups; sequentially presenting the plurality of data bits groups on a data plane as an image frame, wherein each image frame contains a portion of data bits groups; generating a signal beam by emitting a light beam to the plurality of image frames on the data plane when the hologram storage system serves to record data; and, moving a focal point, generated by both the signal beam and a reference beam, to a plurality of positions on a storage medium according to the sequentially-presenting image frames.

The present invention provides a hologram storing method, applied to a hologram storage system, comprising steps of: dividing a codeword, ready to be stored in the hologram storage system, to a plurality of data bits groups; sequentially presenting the plurality of data bits groups on a data plane as an image frame, wherein each image frame contains a portion of data bits groups; generating a signal beam by emitting a light beam to the plurality of image frames on the data plane when the hologram storage system serves to record data; and, moving a focal point, generated by both the signal beam and a reference beam, to a plurality of depths of a position on a storage medium according to the sequentially-presenting image frames.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a diagram showing a conventional hologram storage system;

FIG. 2 is a diagram showing a conventional hologram storage system disclosed in U.S. Pat. No. 5,812,288;

FIG. 3A to FIG. 3C are diagrams showing the storing of a plurality of data bits groups (belong to a same codeword) to different pages in a hologram storage system of the first embodiment of the present invention;

FIG. 4A to FIG. 4C are diagrams showing the storing of a plurality of data bits groups (belong to a same codeword) to different pages in a hologram storage system of the second embodiment of the present invention;

FIG. 5A is a diagram showing a codeword is divided to a plurality of data bits groups;

FIG. 5B is a diagram showing the plurality of data bits groups depicted in FIG. 5A are stored on different pages

FIG. 6A is a diagram showing a codeword is divided to a plurality of data bits groups and a plurality of corresponding parities; and

FIG. 6B is a diagram showing the plurality of data bits groups and the plurality of corresponding parities depicted in FIG. 6A are stored on different pages.

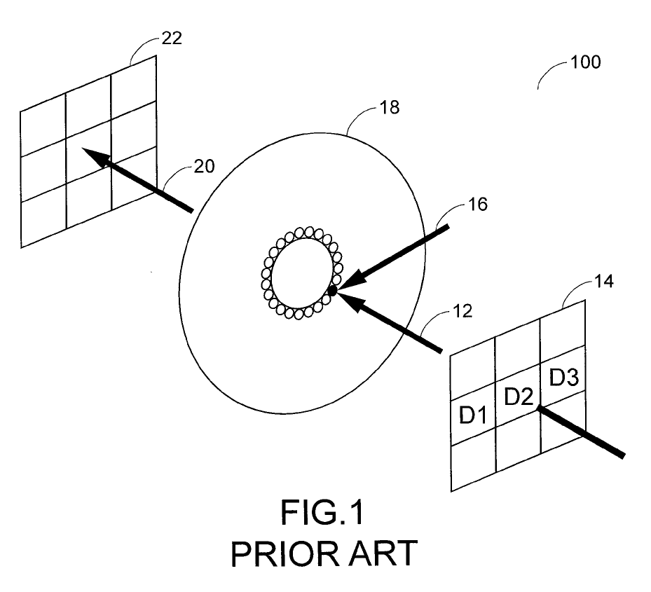

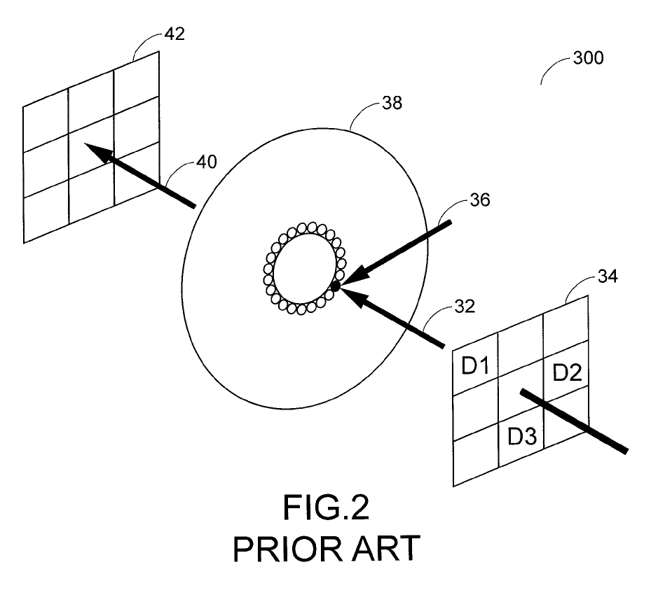

### DETAILED DESCRIPTION OF PREFERRED EMBODIMENTS

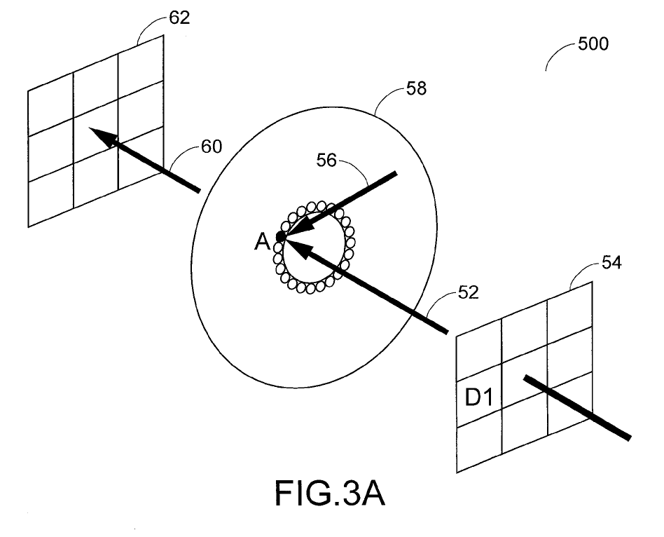

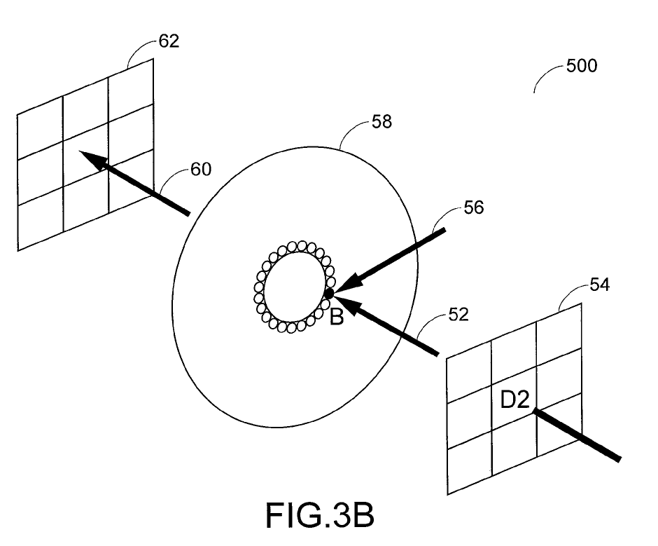

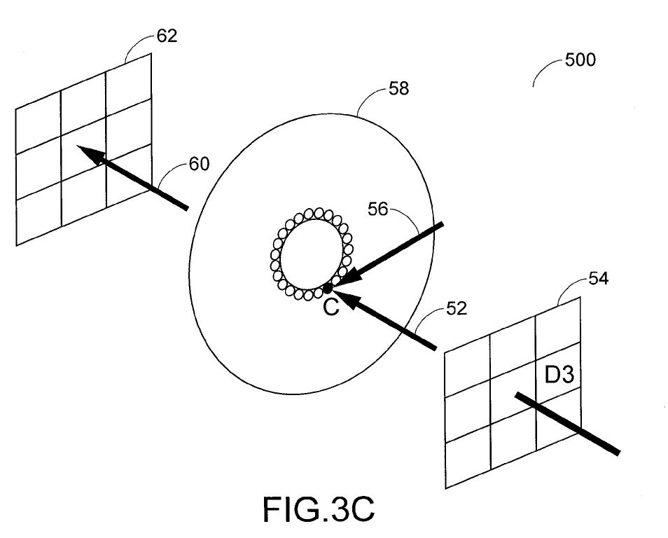

FIG. 3A to FIG. 3C are diagrams showing a plurality of data bits groups (belong to a same codeword) being separately stored on different pages in a hologram storage system of a first embodiment of the present invention. The hologram storage system 500 in the first embodiment of the present invention comprises: a signal beam 52, a data plane 54, a reference beam 56, a storage medium 58, a data beam 60, and a detecting apparatus 62.

In the hologram storage system 500, a codeword is firstly divided to a plurality of data bits groups (i.e., D1, D2, and D3) by the ECC unit. These data bits groups are sequentially presented on the data plane 54 as an image-frame. These data bits groups are then sequentially stored on different pages through the reference beam 56 and the signal beam 52 simultaneously focusing on the storage medium 58.

As depicted in FIG. 3A, the data bits group D1 is presented on the data plane 54 as a first image frame, and the data bits group D1 is then stored on page A through the reference beam 56 and the signal beam 52 simultaneously focusing on the storage medium 58; as depicted in FIG. 3B, the data bits group D2 is presented on the data plane 54 as a second image frame, and the data bits group D2 is then stored on page B through the reference beam 56 and the signal beam 52 simultaneously focusing on the storage medium 58; as depicted in FIG. 3C, the data bits group D3 is presented on the data plane 54 as a third image frame, and the data bits group D3 is then stored on page C through the reference beam 56 and the signal beam 52 simultaneously focusing on the storage medium 58. The pages A, B, and C can be located at different depths of different position on the storage medium 58; or, the pages A, B, and C can be located at a same depth of different positions on the storage medium 58. In the hologram storage system, each position on the storage medium 58 can serve as a Book, and a Book can have a plurality of pages through controlling the signal beam 52 and the reference beam 56 to generate a focal point at different depths of the position. In another word, the pages A, B, and C can be individually located at a same depth of three different Books; or, the pages A, B, and C can be individually located at different depths of three different Books.

When the hologram storage system 500 serves to read data, the reference beam 56 respectively emits to focus on the pages A, B, and C for reading the data bits groups D1, D2, and D3. The data bits groups D1, D2, D3 contained in the data beam 60 are then sequentially received by the detecting apparatus 62. The hologram storage system 500 lastly restores the data bits groups D1, D2, and D3 back to the codeword by the ECC unit.

Because the data bits groups D1, D2, and D3 are respectively stored on three different pages A, B, and C, the ECC unit still has an ability to restore the data bits groups D1, D2, and D3 back to the codeword if any page among pages A, B, and C has a relatively large defect (i.e., a fingerprint or a scratch). For example, if the data bits group D1 and other unrelated data result in poor-quality signals due to the page A has a relatively large defect, the ECC unit still has the ability to overcome the relatively large defect on page A due to the data bits groups D2 and D3 are respectively stored on other pages B and C. Therefore, the ECC unit has the ability to restore the data bits groups D1, D2, and D3 back to the codeword through the unaffected data bits groups D2 and D3.

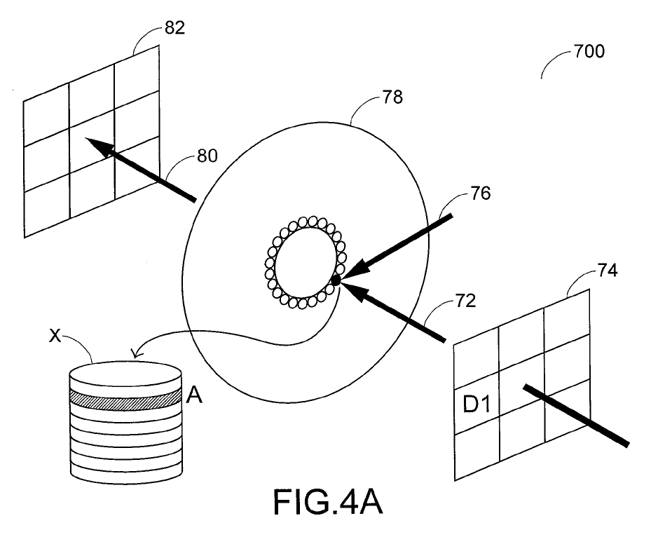

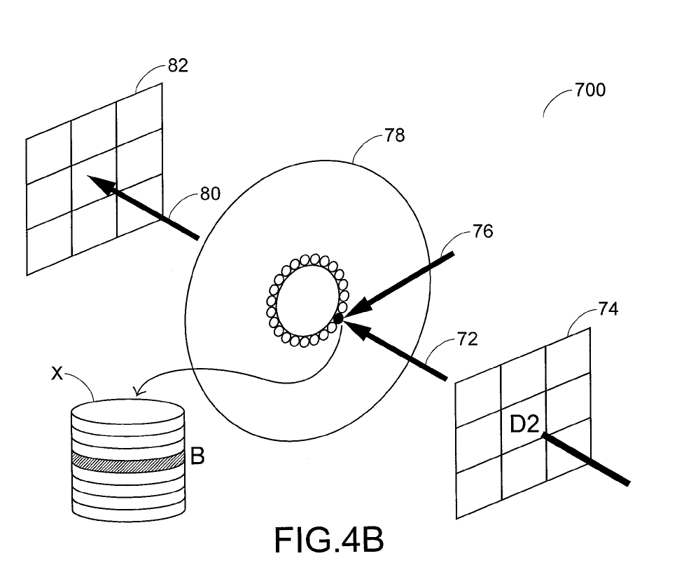

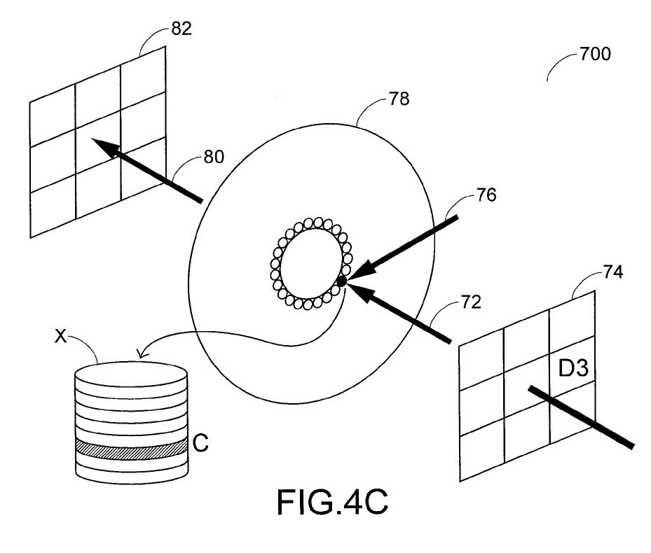

FIG. 4A to FIG. 4C are diagrams showing a plurality of data bits groups (belong to a same codeword) being stored on different pages in a hologram storage system of a second embodiment of the present invention. The hologram storage system 700 in the second embodiment of the present invention comprises: a signal beam 72, a data plane 74, a reference beam 76, a storage medium 78, a data beam 80, and a detecting apparatus 82.

In the hologram storage system 700, a codeword is firstly divided to a plurality of data bits groups (i.e., D1, D2, and D3) by the ECC unit. These data bits groups are sequentially presented on the data plane 74 as an image frame. These data bits groups are then sequentially stored on different pages through the reference beam 76 and the signal beam 72 simultaneously focusing on the storage medium 78, wherein these pages are located at different depths of a same position.

As depicted in FIG. 4A, the data bits group D1 is presented on the data plane 74 as a first image frame, and the data bits group D1 is then stored on page A of Book X through the signal beam 72 and the reference beam 76 simultaneously focusing on a first depth of a position of the storage medium 78; as depicted in FIG. 4B, the data bits group D2 is presented on the data plane 74 as a second image frame, and the data bits group D2 is then stored on page B of Book X through the signal beam 72 and the reference beam 76 simultaneously focusing on a second depth of the same position of the storage medium 78; as depicted in FIG. 4C, the data bits group D3 is presented on the data plane 74 as a third image frame, and the data bits group D3 is then stored on page C of Book X through the signal beam 72 and the reference beam 76 simultaneously focusing on a third depth of the same position of the storage medium 78.

When the hologram storage system 700 serves to read data, the reference beam 76 respectively emits to focus on the pages A, B, and C of Book X for reading the data bits groups D1, D2, and D3. The data bits groups D1, D2, and D3 contained in the data beam 80 are then sequentially received by the detecting apparatus 82. The hologram storage system 700 lastly restores the data bits groups D1, d2, and D3 back to the codeword by the ECC unit.

Because the data bits groups D1, D2, and D3 are respectively stored on three different pages A, B, and C of Book X, the ECC unit still has an ability to restore the data bits groups D1, D2, and D3 back to the codeword when any page among pages A, B, and C results in poor-quality signals according to a slight vibration happened during the process of data recording. For example, if the data bits group D1 and other unrelated data result in poor-quality signals due to the process of recording the data bits group D1 on page A of Book x is affected by a vibration, the ECC unit still has the ability to overcome the vibration according to the rest data bits groups D2 and D3 are respectively stored on the pages B and C having a different depth with the page A. Therefore, the ECC unit still has the ability to restore the data bits groups D1, D2, and D3 back to the codeword through the unaffected data bits groups D2 and D3.

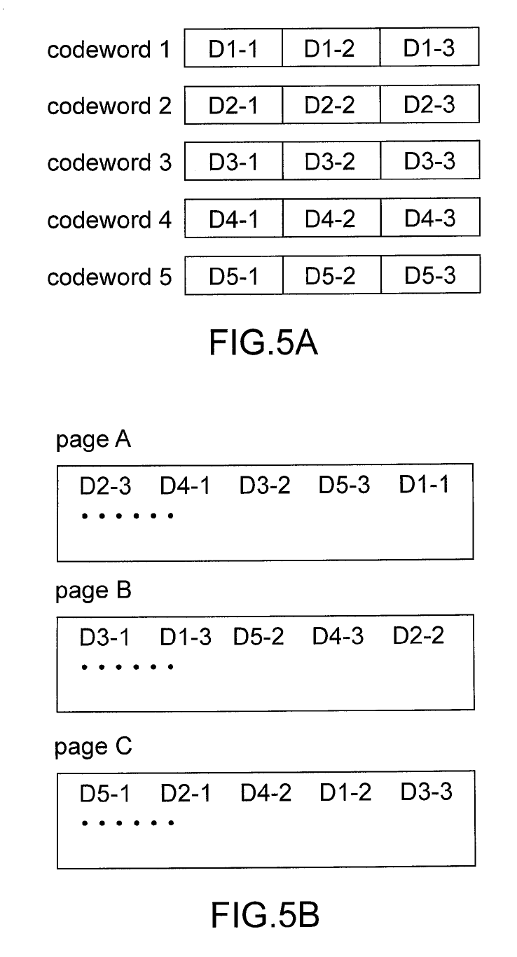

In the present invention, storing a plurality of data bits groups (belong to a same codeword) on different pages can be achieved through several methods. FIG. 5A and FIG. 5B are diagrams showing a method used for storing the plurality of data bits groups (belong to a same codeword) on different pages in the present invention. As depicted in FIG. 5A, the codeword 1 is firstly divided to data bits groups D1-1, D1-2, and D1-3 by the ECC unit; the codeword 2 is divided to data bits groups D2-1, D2-2, and D2-3 by the ECC unit; the codeword 3 is divided to data bits groups D3-1, D3-2, and D3-3 by the ECC unit; the codeword 4 is divided to data bits groups D4-1, D4-2, and D4-3 by the ECC unit; and the codeword 5 is divided to data bits groups D5-1, D5-2, and D5-3 by the ECC unit. Moreover, the first digit in the code of the data bits group stands for the data bits group belongs to which codeword; the second digit in the code of the data bits group stands the data bits group belongs to which part of the codeword. For example, the code D3-2 represents the data bits group belongs to the second part of the codeword 3.

In the method, the sum of the first digit and the second digit in a code of a data bits group is divided by a specific number (i.e., 3), and the remainder stands for which page is selected for storing the data bits group. As depicted in FIG. 5B, the sum of first digit and second digit in code D1-1 is 2, and the remainder of 2 divided by 3 is 2, therefore, the data bits group D1-1 is stored on page A; accordingly, the data bits groups D2-3, D3-2, D4-1, and D5-3 are all stored on page A. The sum of first digit and second digit in code D1-3 is 4, and the remainder of 4 divided by 3 is 1, therefore, the data bits group D1-3 is stored on page B; accordingly, the data bits groups D2-2, D3-1, D4-3, and D5-2 are all stored on page B. The sum of first digit and second digit in code D1-2 is 3, and the remainder of 3 divided by 3 is 0, therefore, the data bits group D1-2 is stored on page C; accordingly, the data bits groups D2-1, D3-3, D4-2, and D5-1 are all stored on page C. Obviously, all the data bits groups belonging to a same codeword are guaranteed to be separately stored on different pages according to the method.

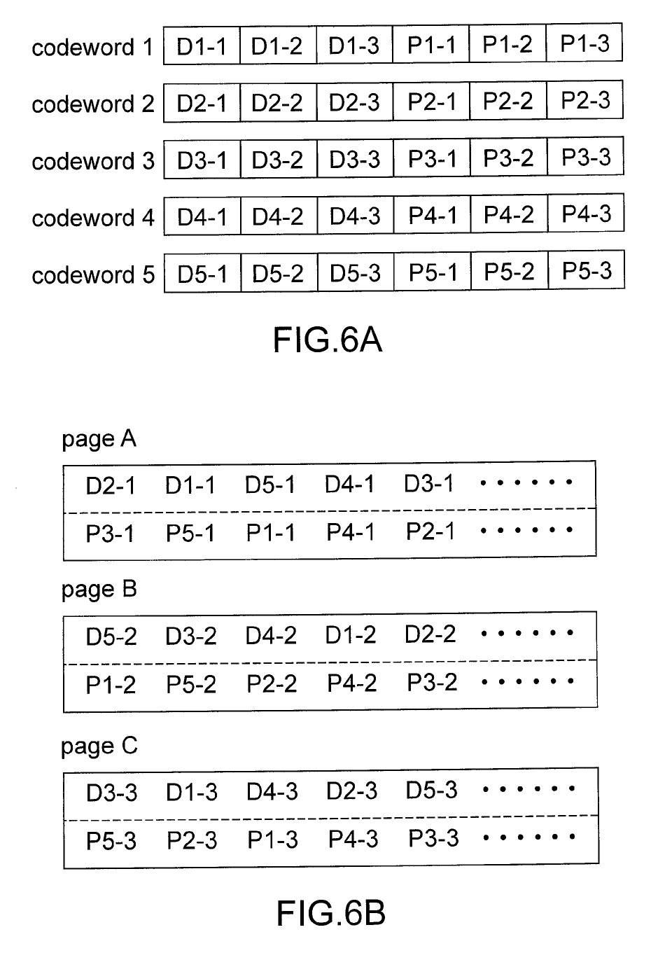

FIG. 6A and FIG. 6B are diagrams showing another method used for storing a plurality of data bits groups (belong to a same codeword) on different pages in the present invention. As depicted in FIG. 6A, the codeword 1 is firstly divided to data bits groups D1-1, D1-2, D3, and parities P1-1, P1-2, P1-3, wherein parities P1-1, P1-2, P1-3 are respectively corresponding to the data bits groups D1-1, D1-2, D3; the codeword 2 is divided to data bits groups D2-1, D2-2, D2-3, and parities P2-1, P2-2, P2-3, wherein parities P2-1, P2-2, P2-3 are respectively corresponding to the data bits groups D2-1, D2-2, D2-3; the codeword 3 is divided to data bits groups D3-1, D3-2, D3-3, and parities P3-1, P3-2, P3-3, wherein parities P3-1, P3-2, P3-3 are respectively corresponding to the data bits groups D3-1, D3-2, D3-3; the codeword 4 is divided to data bits groups D4-1, D4-2, D4-3, and parities P4-1, P4-2, P4-3, wherein parities P4-1, P4-2, P4-3 are respectively corresponding to the data bits groups D4-1, D4-2, D4-3; the codeword 5 is divided to data bits groups D5-1, D5-2, D5-3, and parities P5-1, P5-2, P5-3, wherein parities P5-1, P5-2, P5-3 are respectively corresponding to the data bits groups D5-1, D5-2, D5-3. Moreover, the first digit in the code of data bits group or the parity stands for the data belongs to which codeword, and the second digit stands for the data belongs to which part of the codeword. For example, the code D3-2 represents the data bits group belongs to the second part of the codeword 3, the code P3-2 represents the parity belongs to the second part of the codeword 3. Moreover, each page in the method is divided to two parts, wherein one part is for storing the data bits groups, and the other part is for storing the parities.

In the method, the data bits groups and the parties having a same second digit in codes are stored on a same page. As depicted in FIG. 6B, the second digit in codes D1-1, D2-1, D3-1, D4-1, and D5-1 is 1, therefore, the data bits groups D1-1, D2-1, D3-1, D4-1, and D5-1 are all stored on the up-half part of page A; the second digit in codes P11-1, P2-1, P3-1, P4-1, and P5-1 is 1, therefore, the parities P1-1, P2-1, P3-1, P4-1, and P5-1 are all stored on the down-half part of page A. Accordingly, the second digit in codes D1-2, D2-2, D3-2, D4-2, and D5-2 is 2, therefore, the data bits groups D1-2, D2-2, D3-2, D4-2, and D5-2 are all stored on the up-half part of page B; the second digit in codes P1-2, P2-2, P3-2, P4-2, and P5-2 is 2, therefore, the parities P1-2, P2-2, P3-2, P4-2, and P5-2 are all stored on the down-half part of page B. Accordingly, the second digit in codes D1-3, D2-3, D3-3, D4-3, and D5-3 is 3, therefore, the data bits groups D1-3, D2-3, D3-3, D4-3, and D5-3 are all stored on the up-half part of page C; the second digit in codes P1-3, P2-3, P3-3, P4-3, and P5-3 is 3, therefore, the parities P1-3, P2-3, P3-3, P4-3, and P5-3 are all stored on the down-half part of page C. Obviously, all the data bits groups and its corresponding parities belonging to a same codeword are guaranteed to separately stored on different pages according to the method.

In the present invention, all the data bits groups belong to a same codeword can be separately stored on different pages, so as the ECC unit has a higher ability to restore back the plurality data bits groups to the codeword when one of these data bits group is affected by a relative large affect or a vibration.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A hologram storage system, comprising:
a codeword capable of being divided to a plurality of data bits groups by an error-correction coding unit;
a data plane, for sequentially presenting a plurality of image frames, wherein each image frame contains a portion of the data bits groups;
a storage medium, for storing the plurality of sequentially-presenting image frames;
a signal beam containing the plurality of sequentially-presenting image frames; and
a reference beam together with the signal beam to form a focal point; wherein the focal point can be moved to a plurality of positions in the storage medium according to the plurality of sequentially-presenting image frames.

2. The hologram storage system according to claim 1, wherein the signal beam is generated by a light beam emitted through the data plane.

3. The hologram storage system according to claim 1, wherein the hologram storage system further comprises:
a detecting apparatus, for receiving a data beam containing the portion of data bits groups when the hologram storage system serves to read data.

4. The hologram storage system according to claim 3, wherein the data beam is generated through the reference beam focusing in the plurality of positions of the storage medium.

5. A hologram storage system, comprising:
a codeword capable of being divided to a plurality of data bits groups by an error-correction coding unit;
a data plane, for sequentially presenting a plurality of image frames, wherein each image frame contains a portion of data bits groups;
a storage medium, for storing the plurality of sequentially-presenting image frames;
a signal beam containing the plurality of sequentially-presenting image frames; and
a reference beam together with the signal beam to form a focal point;
wherein the focal point can be moved to a plurality of depths of a position in the storage medium according to the plurality of sequentially-presenting image frames.

6. The hologram storage system according to claim 5, wherein the signal beam is generated by a light beam emitted through the data plane.

7. The hologram storage system according to claim 5, wherein the hologram storage system further comprises:
a detecting apparatus, for receiving a data beam containing the portion of data bits groups when the hologram storage system serves to read data.

8. The hologram storage system according to claim 7, wherein the data beam is generated through the reference beam focusing in the plurality depths of the position of the storage medium.

9. A hologram storing method, applied to a hologram storage system, comprising steps of:
dividing a codeword, ready to be stored in the hologram storage system, to a plurality of data bits groups;
sequentially presenting the plurality of data bits groups on a data plane as an image frame, wherein each image frame contains a portion of data bits groups;
generating a signal beam by emitting a light beam to the plurality of image frames on the data plane when the hologram storage system serves to record data; and
moving a focal point, generated by both the signal beam and a reference beam, to a plurality of positions on a storage medium according to the sequentially-presenting image frames.

10. The method according to claim 9, wherein a data beam is generated by focusing the reference beam on the plurality of positions of the storage medium when the hologram storage system serves to read data.

11. The method according to claim 10, wherein the portion of data bits groups contained in the data beam can be received by a detecting apparatus.

12. A hologram storing method, applied to a hologram storage system, comprising steps of:
dividing a codeword, ready to be stored in the hologram storage system, to a plurality of data bits groups;
sequentially presenting the plurality of data bits groups on a data plane as an image frame, wherein each image frame contains a portion of data bits groups;
generating a signal beam by emitting a light beam to the plurality of image frames on the data plane when the hologram storage system serves to record data; and
moving a focal point, generated by both the signal beam and a reference beam, to a plurality of depths of a position on a storage medium according to the sequentially-presenting image frames.

13. The method according to claim 12, wherein a data beam is generated by focusing the reference beam in the plurality of depths of the position of the storage medium when the hologram storage system serves to read data.

14. The method according to claim 13, wherein the portion of data bits groups contained in the data beam can be received by a detecting apparatus.
